(19) United States
(12) Patent Application Publication
(10) Pub. No.: US 2023/0008557 A1
(43) Pub. Date: Jan. 12, 2023

(54) SPLIT-FIELD OPTICS FOR IMAGING AND RANGING

(71) Applicant: OWL AUTONOMOUS IMAGING, INC., FAIRPORT, NY (US)

(72) Inventors: Eugene M. Petilli, Victor, NY (US); Georg K. Nadorff, Victor, NY (US)

(73) Assignee: OWL AUTONOMOUS IMAGING, INC., FAIRPORT, NY (US)

(21) Appl. No.: 17/858,851

(22) Filed: Jul. 6, 2022

Related U.S. Application Data
(60) Provisional application No. 63/219,350, filed on Jul. 7, 2021.

(51) Int. Cl. G02B 27/28; G02B 13/00

(52) U.S. Cl. CPC G02B 27/283; G02B 13/0035

(57) ABSTRACT

An imaging apparatus has one or more lenses with a common optical axis and that define an image plane. A splitting optic is disposed to split the light along the optical axis to provide, at the image plane, at least a first copy of an image at a first magnification and a second copy of the image at a second magnification different from the first magnification.

### FIELD

The present disclosure generally relates to imaging for range detection and more particularly to a split lens configuration for providing multiple views of the image field.

### BACKGROUND

Imaging employs a detector that detects photons (ultraviolet, visible, infrared, thermal) radiated from a subject and converts the detected photons into electric signals. The imaging device can be used in various applications, such as in area monitoring, night vision devices, thermography, or in a forward-monitoring device mounted on a vehicle or an aircraft, for example.

Modern computational photography methods are able to estimate range corresponding to each pixel of the image content. Both the accuracy and maximum range of these estimates is dependent on the effective pixels per radian over the field of view (FoV).

Imaging systems for mobility applications, such as for autonomous automobiles, can have conflicting requirements. Systems designed for autonomous vehicles need to image and range curb-to-curb (˜120 deg FoV) out to ˜30 m and need further visibility to 200 m over a much smaller FoV of ˜20 deg. To achieve this performance, most mobility applications employ multiple cameras with different FoV. This introduces a new set of challenges for rectification (alignment) and occlusions.

Historically, imaging systems used aspect ratios that were substantially square, such as 4:3 VGA. Aspect ratios in today's imaging apparatus are often more asymmetric, with 16:9 HD and 16:10 WXGA being very common. Vehicular mobility applications, not needing to image as much skyline as cinema applications, are well served with ultrawide aspect ratios such as 32:10. This aspect ratio can be provided using only half of a 16:10 detector array.

For coarse object, movement, and range detection, speed of detection or identification can be of high value, while image quality considerations are comparatively less important. To support these and other functions for applications that employ computational imaging techniques, there is room for improvement in thermal imaging devices for rapid detection and identification of live creatures or heat sources in the visual field.

### SUMMARY

The Applicants address the problem of imaging for range detection. With this object, the Applicants describe apparatus for range detection that provides a significant amount of information related to position and movement for objects in the visual field.

From an aspect of the present disclosure, there is provided an imaging apparatus comprising:
a) one or more lenses that have a common optical axis and that define an image plane;
b) a splitting optic disposed to split the light along the optical axis to provide, at the image plane, at least:
   (i) a first copy of an image at a first magnification;
   (ii) a second copy of the image at a second magnification different from the first magnification;
c) a detector at the image plane and configured to capture the images from the first and second magnification;
d) a computational unit configured to compute distance information according to content of the first and second copies of the image.

### DRAWINGS

FIG. 1 is a perspective diagram that shows generating a split field from an optical component.

FIGS. 2A and 2B show side view schematics for a lens attachment without and with range detection components.

FIG. 3 is an enlarged side view showing components for forming a portion of the split field.

FIG. 4 is an enlarged side view showing components for forming an alternate portion of the split field.

FIG. 5 shows the two images that can be formed on the detector.

FIG. 6 shows the perspective diagram of FIG. 1 with a horizontal baffle that defines a field stop inserted in image-space.

FIGS. 7 and 8 show an alternate embodiment that shows different portions of the FOV, with some overlap, and provides the image content for different portions onto the same detector

FIG. 9 shows a plane parallel window located at the system Aperture-Stop position.

FIG. 10 shows the plane parallel window truncated in half. Half of the light is lost, but the field-of-view (FOV) remains identical. The intended FOV of FIGS. 7 and 8 is indicated in 14.

FIG. 11 shows use of a wedge component for shifting and re-mapping the intended FOV of FIG. 10 to the lower and centered section of the detector area.

FIG. 12 shows the other half of the light from the original FOV passing through another truncated plane parallel window, and the intended remaining FOV of FIGS. 7 and 8 is indicated in 14.

FIG. 13 shows use of a wedge for shifting and re-mapping the intended FOV of FIG. 10 to the upper and centered section of the detector area.

FIG. 14 shows use of a split prism that re-maps two copies of the object field to the focal plane.

FIG. 15 shows perspective views with a split prism at various positions along the optical path.

FIG. 16 shows two different views of the object field as provided on the focal plane according to an embodiment.

FIG. 17 is a perspective view that shows an optical configuration that forms a 2×2 pattern of images onto the focal plane at the detector.

FIG. 18 is a side view schematic that shows forming an intermediate image and relaying the image through a splitter element to form multiple sub-images.

FIG. 19 shows a test target image formed from uniquely patterned blocks.

FIG. 20 is a simulated view of the image plane that shows rotated and shifted demagnified views of the test pattern of FIG. 19.

FIG. 21 is a simulated view of the image plane that shows rotated and shifted unmagnified views of the test pattern of FIG. 19.

### DESCRIPTION

The following is a detailed description of the preferred embodiments of the disclosure, reference being made to the drawings in which the same reference numerals identify the same elements of structure in each of the several figures.

Where they are used, the terms “first”, “second”, and so on, do not necessarily denote any ordinal, sequential, or priority relation, but are simply used to more clearly distinguish one element or set of elements from another, unless specified otherwise.

In the context of the present disclosure, the term “coupled” is intended to indicate a mechanical association, connection, relation, or linking, between two or more components, such that the disposition of one component affects the spatial disposition of a component to which it is coupled. For mechanical coupling, two components need not be in direct contact, but can be linked through one or more intermediary components.

Embodiments of the present disclosure address the problem of generating image content for range finding by various apparatus and methods that provide, on the same image detector, different magnifications or views of the same optical object. This technique enables the use of a range of computational imaging tools and provides useful information acquired from angular aspects of light from the object field.

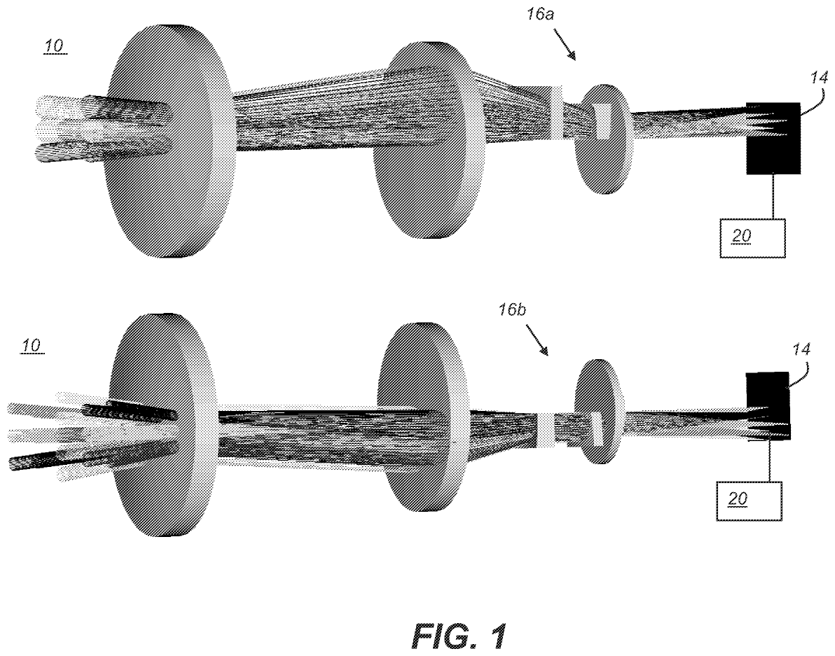

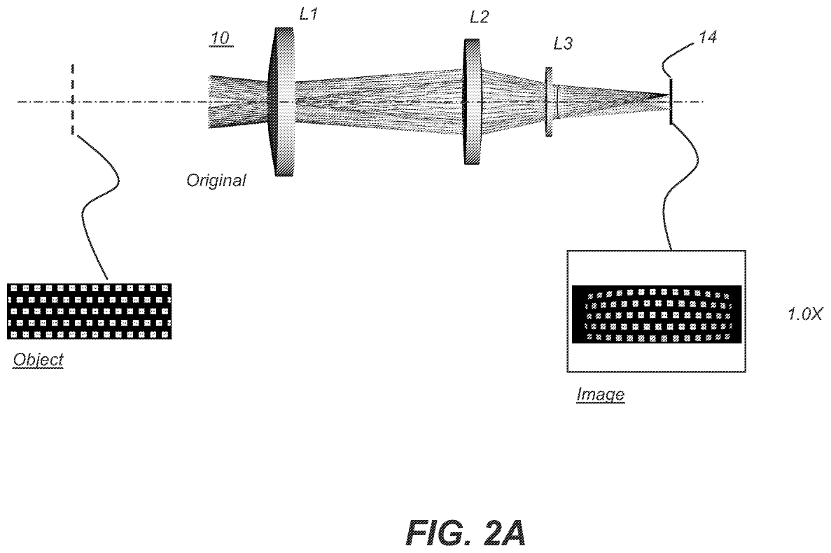

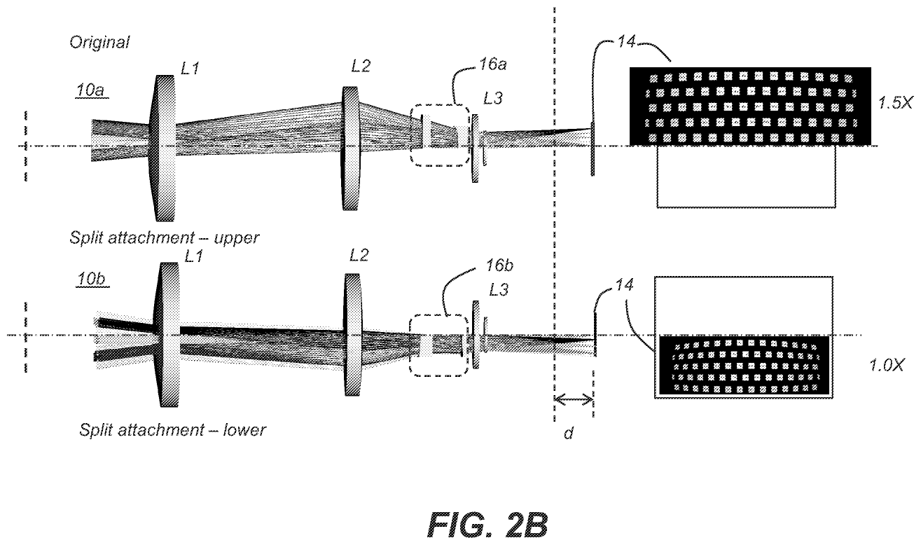

The perspective schematic views of FIG. 1 and side views of FIGS. 2A and 2B show an imaging apparatus 10 having light paths for forming two separate images on a detector 14 that can be, for example, a focal plane array detector, familiar to those skilled in thermal imaging and/or range sensing. Lenses L1 and L2 can be a standalone prime objective lens assembly, or a portion thereof, that is particularly suited for thermal imaging. Included is an attachment lens assembly containing splitting optics 16a and 16b. Window L3 belongs to the detection apparatus that houses detector 14 along with related optics and optional support components such as a Cold-Stop and cryogenic cooler assembly.

Detector 14 at the image plane can be configured with a processor 20 to compute distance information according to content of the first and second copies of the image.

FIG. 2A shows, as a baseline, the prime objective attached to the detector without the needed modification for forming two views of the object field. The rectangular area of detector 14 is represented, relative to image content. The modified arrangements for portions 10a and 10b in FIG. 2B show that by adding the lens attachment for split field viewing, the image plane at detector 14 is shifted by a distance, d.

As shown in the side views of FIG. 2B, imaging apparatus portion 10a is modified by adding retrofocus adapter elements and forms an image of the object field that is magnified, 1.5× in this example, and that is sensed on the upper portion of detector 14. A second imaging apparatus portion 10b forms an image of the object field at 1.0× magnification on detector 14. Thus, the same image plane, at the shifted position of detector 14, serves for images of different magnification in the embodiment shown.

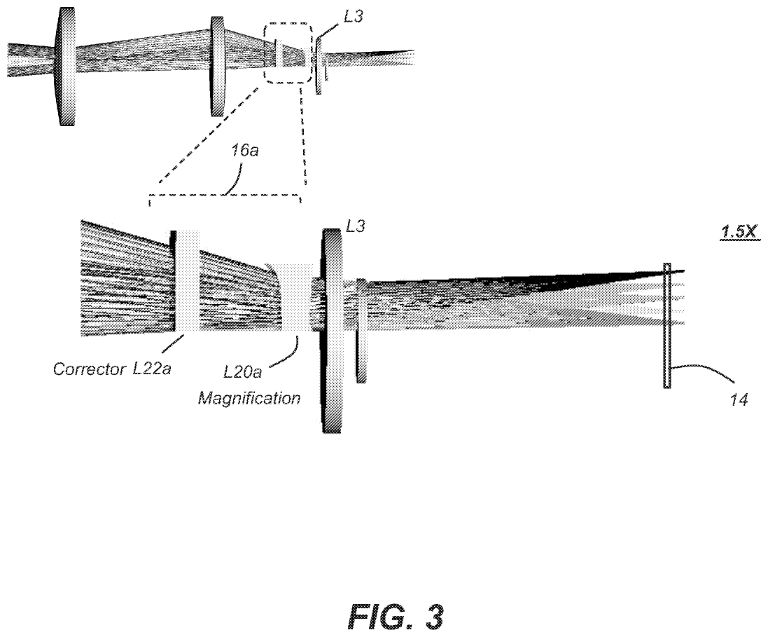

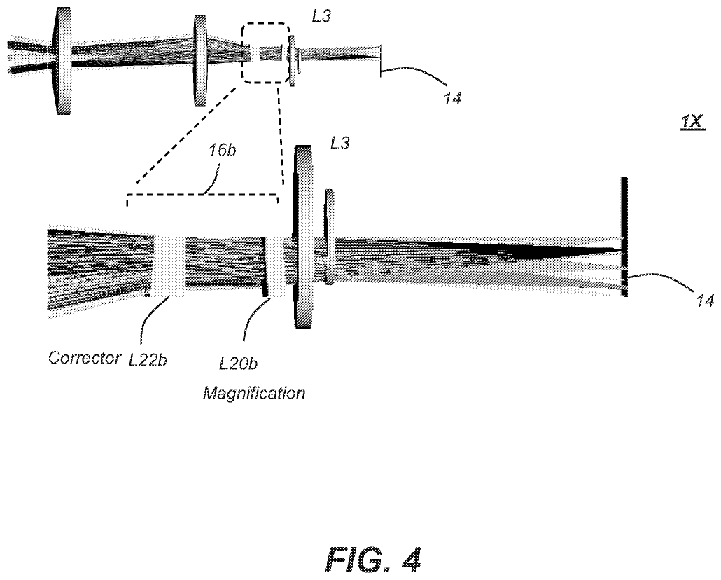

FIGS. 3 and 4 are enlarged side views showing exemplary components that form splitting optics 16a and 16b, respectively. Along each optical path there is a magnification changer L20a, L20b and a corrector L22a, L22b, respectively. Both types of lenses are needed to effect a magnification change. The L20 lens (shown herein as either L20a or L20b lens) changes the focal length of the overall optical system, thereby changing the detection angular field-of-view for a fixed detector size. For magnification>1, a smaller angular field is produced when L20 is designed to increase the system focal length. For magnification between 0 and 1 (that is, demagnification), a larger angular field is produced when L20 is designed to decrease the system focal length. The corresponding L22 lens (L22a or L22b) is used to compensate the image distance to remain in focus, so that a different magnification in the other portions of the split image can share the same detector plane.

According to an embodiment of the present disclosure, one of lenses L20a, L20b can be a telephoto lens; the other lens of this pair can be a wide-angle lens.

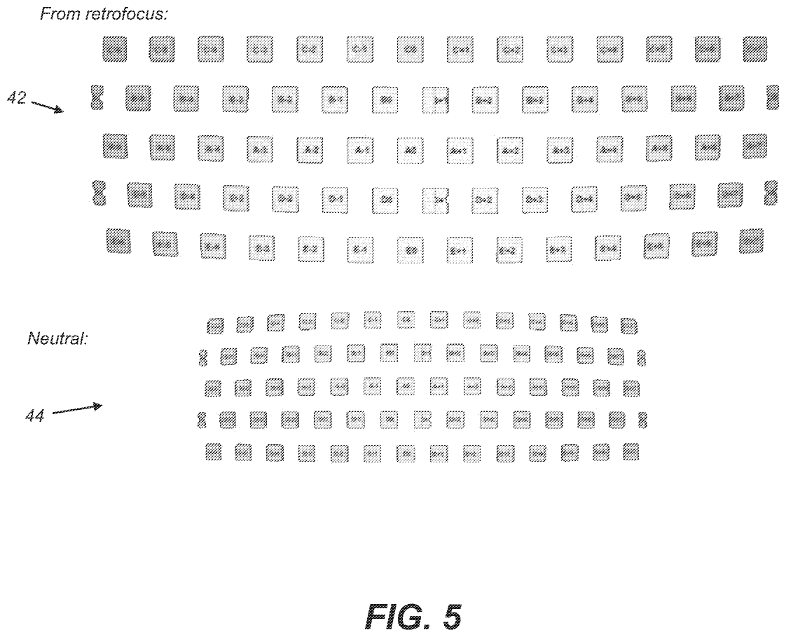

FIG. 5 shows two sample images 42 and 44 that can be formed on detector 14. An image 42 from the retrofocus portion 10a has 1.5× magnification (and a correspondingly narrower field-of-view for a fixed detector size). Image 44 from the neutral (un-magnified) optics components has 1.0× magnification. Both images 42 and 44 have the same image plane.

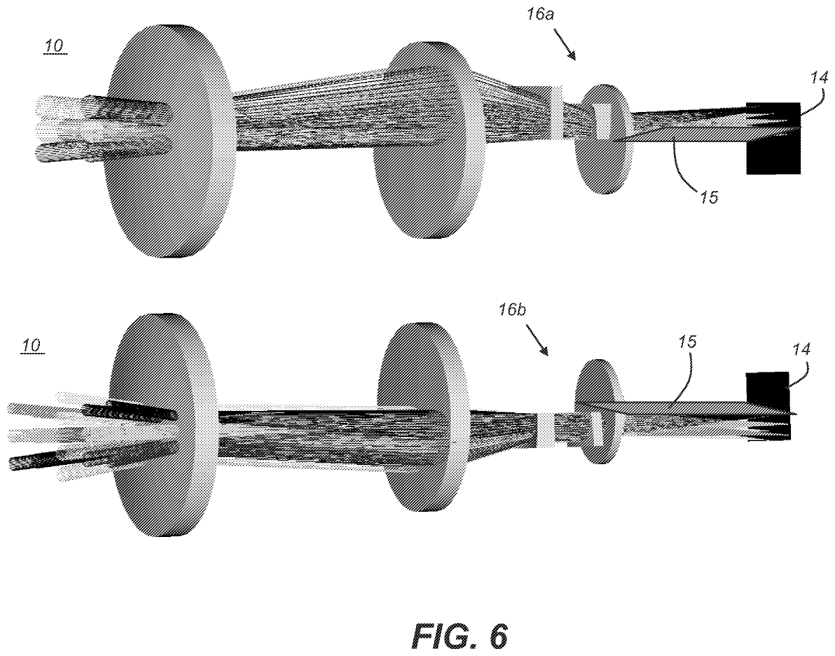

The possibility of crosstalk exists, wherein light from edge portions of individual sub-images can leak into adjacent regions on the common image plane which are reserved for receiving a different sub-image. To prevent this from happening, opaque baffles can be strategically positioned to block undesired light from outside of the intended FOV. These baffles can act as a Field-Stop to define the precise sub-FOV regions. FIG. 6 duplicates FIG. 1 with the addition of a baffle 15 that acts as a field stop. One aspect of these baffles 15 is that, in general, they seat along planes parallel to the main lens original optical axis (with azimuthal angle dependent on the design of the splitting optics), as opposed to being perpendicular to the optical axis as baffles are traditionally oriented.

It can be appreciated that there can be a number of variations for providing multiple images having different magnifications and shifted to different areas of detector 14. Various types of wedge arrangements can be applied to the problem of positioning the image content on the detector, as shown in subsequent examples.

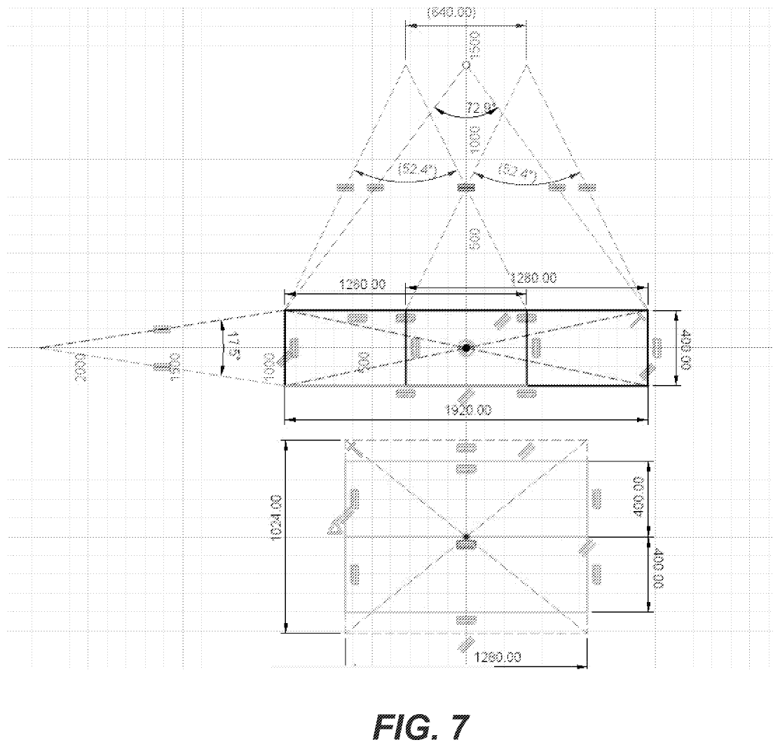

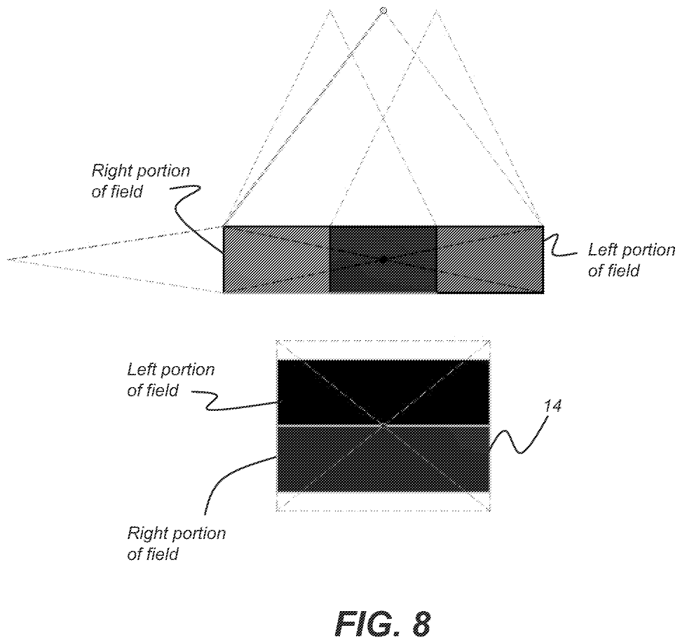

FIGS. 7 and 8 depict an alternate embodiment that shows different portions of the FOV, with some overlap, and provides the image content for different portions onto the same detector 14. An arrangement of wedges or optical prisms adjusts the positioning of the image content from the FOV, so that a central portion of the detector 14 has some overlapped image areas, enabling stereo view content to be extracted. Pixel pitch can be optimized, allowing more exact measurement of disparity.

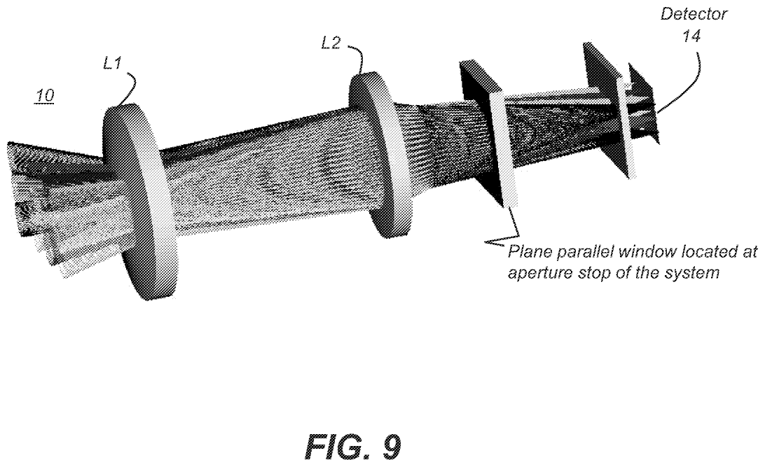

FIG. 9 shows a plane parallel window located at the Aperture-Stop of the system, which is designed to have a Cold-Stop located at this position; this window indicates where components for changing magnification and shifting image content, relative to the detector, can be provided.

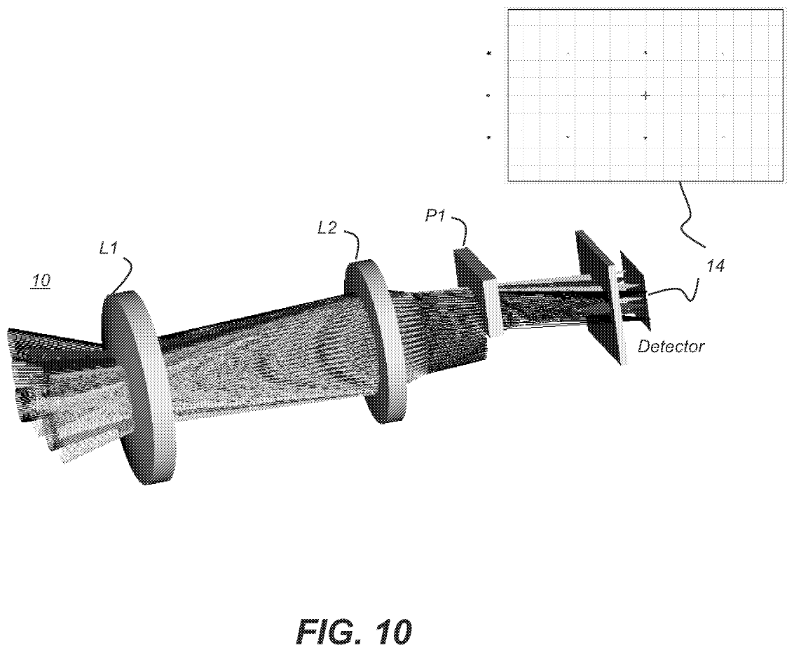

FIG. 10 shows the plane parallel window of FIG. 9 truncated in half. Because the window is located at the Aperture-Stop, half of the light is lost from the truncated window, while the field-of-view (FOV) remains unchanged. The intended FOV of FIGS. 7 and 8 is indicated in the mapping for detector 14. As FIG. 10 shows, the addition of a wedge or prism into one portion of the optical path enables re-mapping of the light along a portion of the optical path to a lower portion of the detector 14. FIG. 10 shows the image plane mapping for a portion of the image plane.

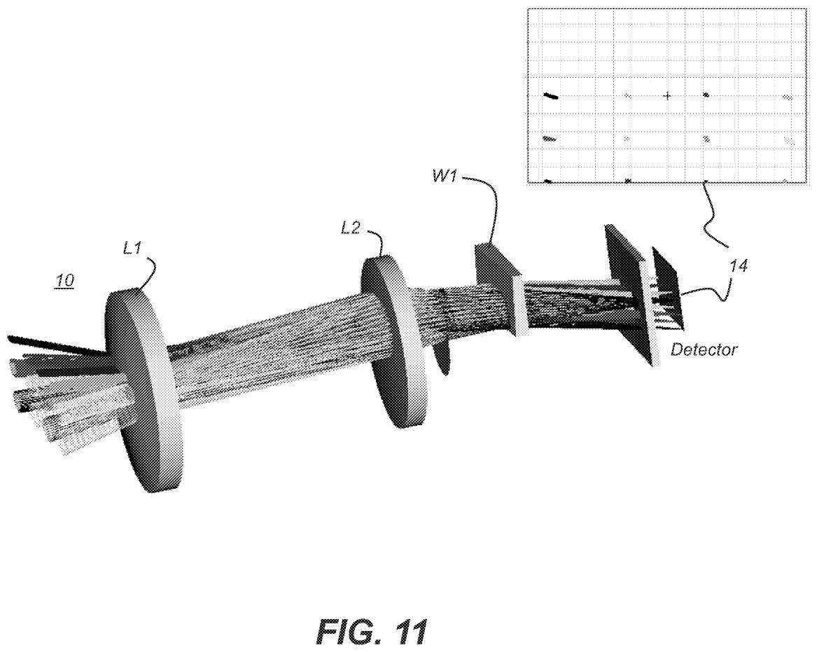

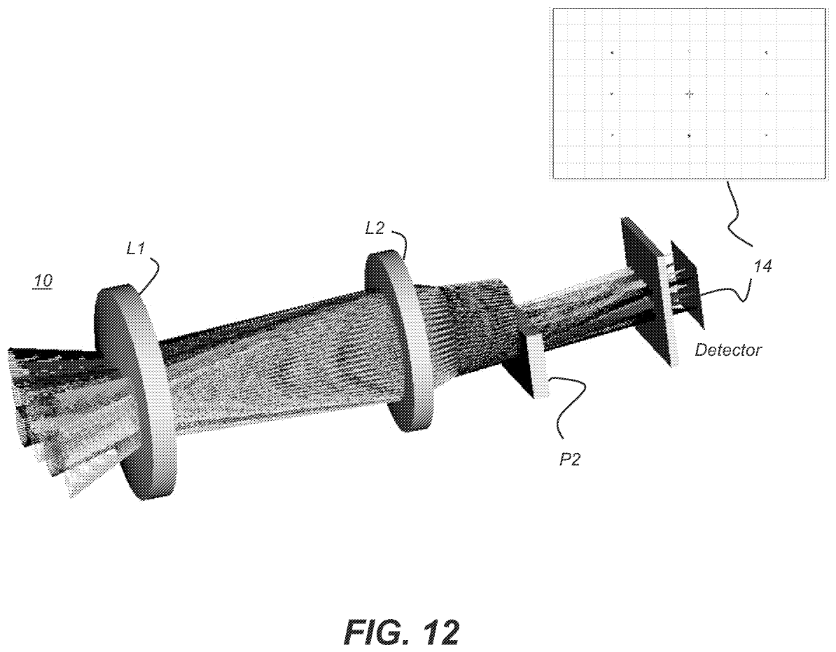

The optical path shown in FIG. 11 includes a wedge W1 that is disposed to shift light to the lower half of the focal plane at detector 14. In FIG. 12 a tilt of surface 51 is sufficient to split contents of the window to a corresponding portion of detector 14.

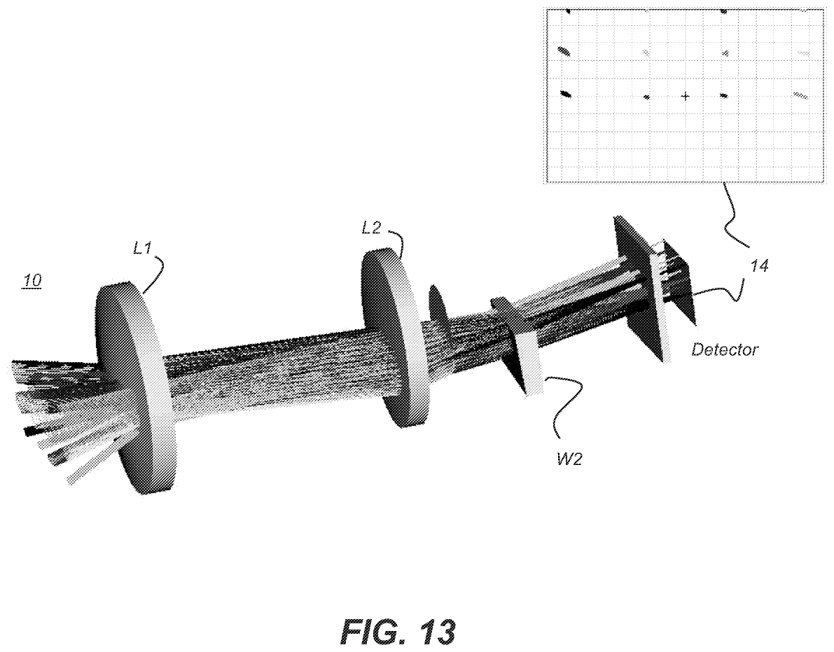

FIG. 13 shows use of a wedge W2 to re-map the object field to the upper half of the focal plane.

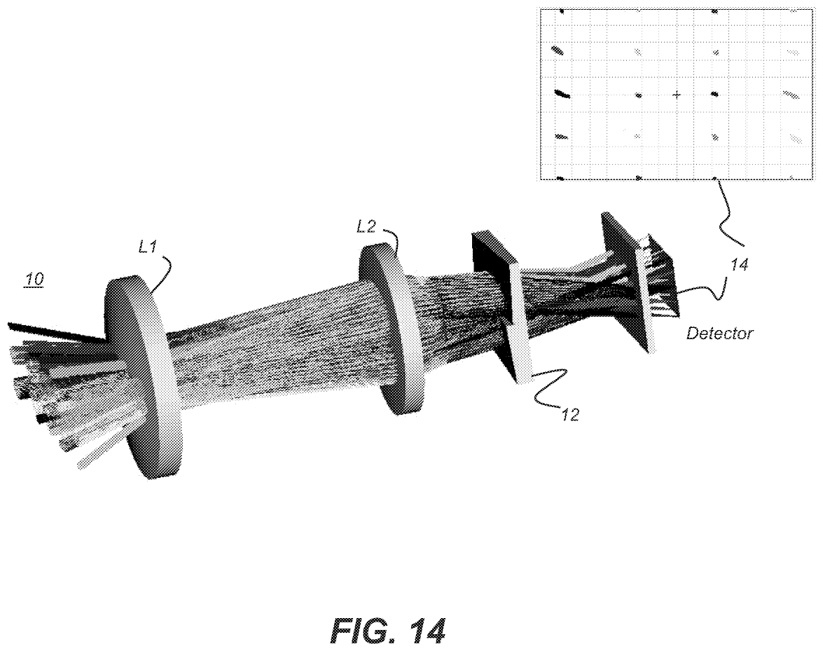

FIG. 14 shows use of a split prism 12 that re-maps two copies of the object field to the focal plane of detector 14.

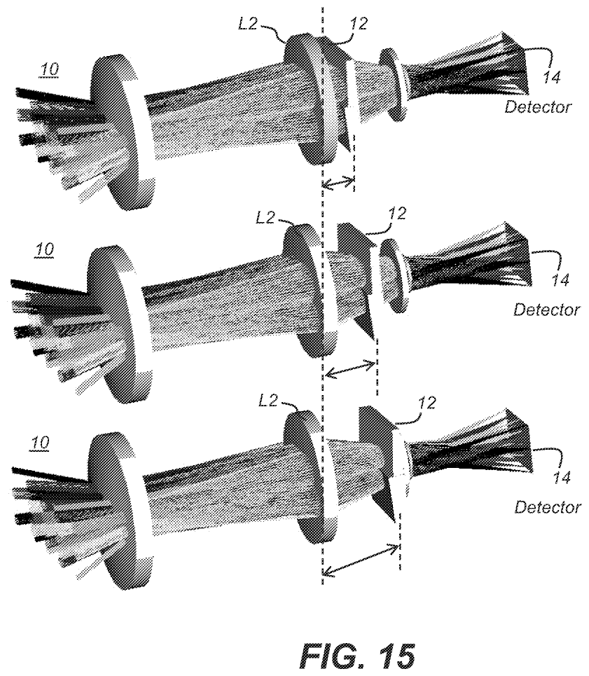

FIG. 15 shows perspective views with a split prism 12 shifted to various positions along the optical path. This allows split prism 12 to vary the positioning of the object field content relative to the focal plane. Relative to lens L2, the wedge angles of split prism 12 would need to be adjusted to accommodate different positions for mapping the image content.

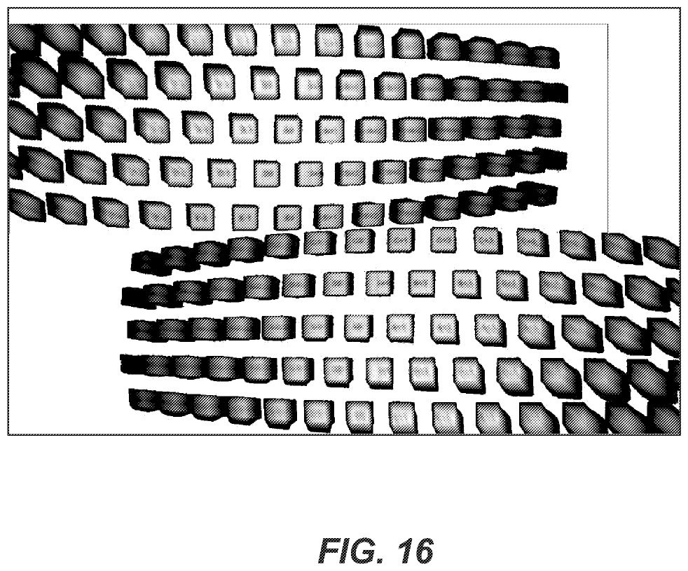

FIG. 16 shows two different views of the object field as provided at the focal plane according to an embodiment.

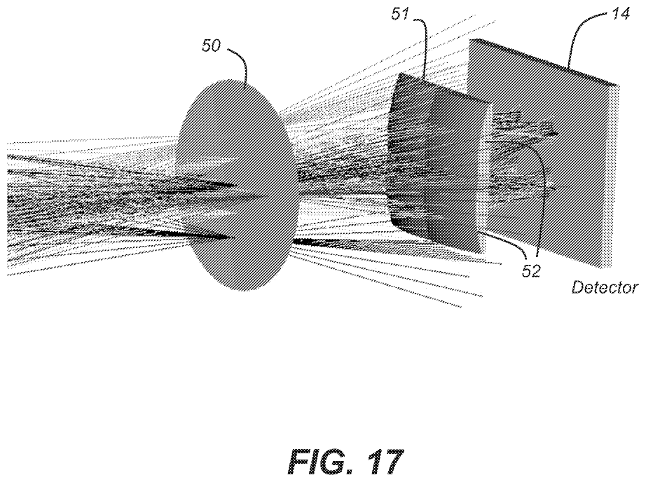

Preceding embodiments have presented apparatus and techniques that form, simultaneously and from the same optical object, dual images on the same image plane, including images at different magnifications. FIG. 17 and following show embodiments that can form more than two images onto the same image plane.

FIG. 17 is a perspective view that shows an optical configuration that forms a 2×2 pattern of images onto the focal plane at detector 14. A splitter element 51 has an array of four lenslets 52 that can be shaped and tilted for providing the multiple images. The lenslets have generally aspheric profiles and can incorporate compound wedge angles to be able to adjust the positioning and overlap of the individual sub-FOVs similar to the procedure described for FIGS. 7 through 16.

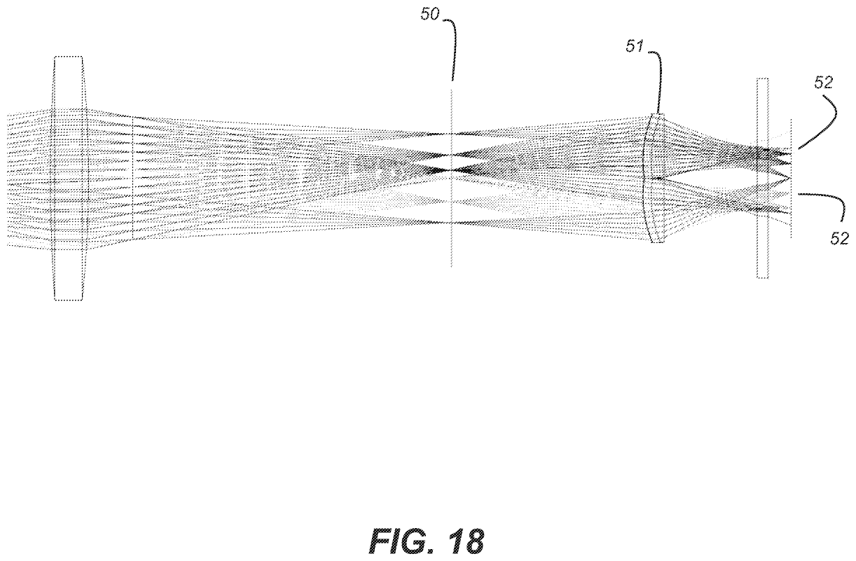

FIG. 18 is a side view schematic that shows forming an intermediate image and relaying the primary aerial image 50 through the splitter element 51 to form multiple sub-images 52. The focal length of splitter element 51 and conjugate distances are chosen to provide either magnified or demagnified sub-images 52 of the primary aerial image 51. In the example shown, a magnification of 0.61× is achieved.

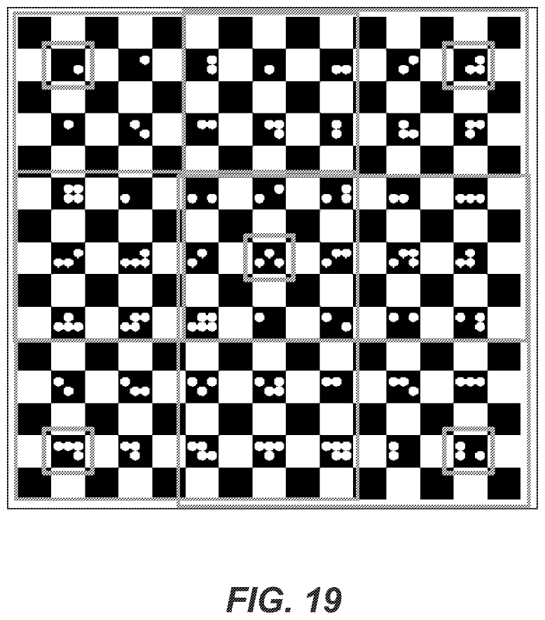

FIG. 19 shows a test target image formed from uniquely patterned blocks in a 15×15 arrangement. Within this pattern, a base image is duplicated, rotated, and overlaid to form the composite test target.

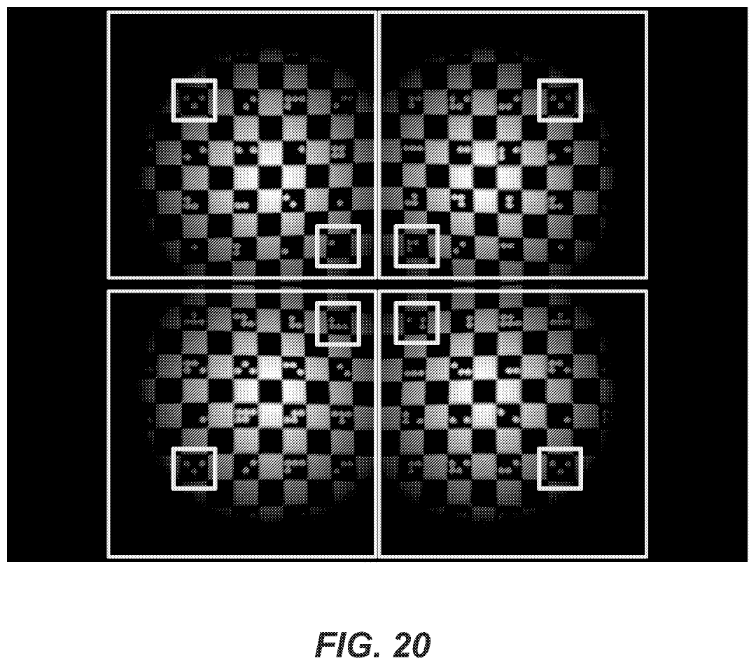

FIG. 20 is a simulated view of the image plane that shows rotated and shifted views of the test pattern of FIG. 19, with the image acquired using the 4×4 lenslet array of FIG. 18 at 0.61× demagnification.

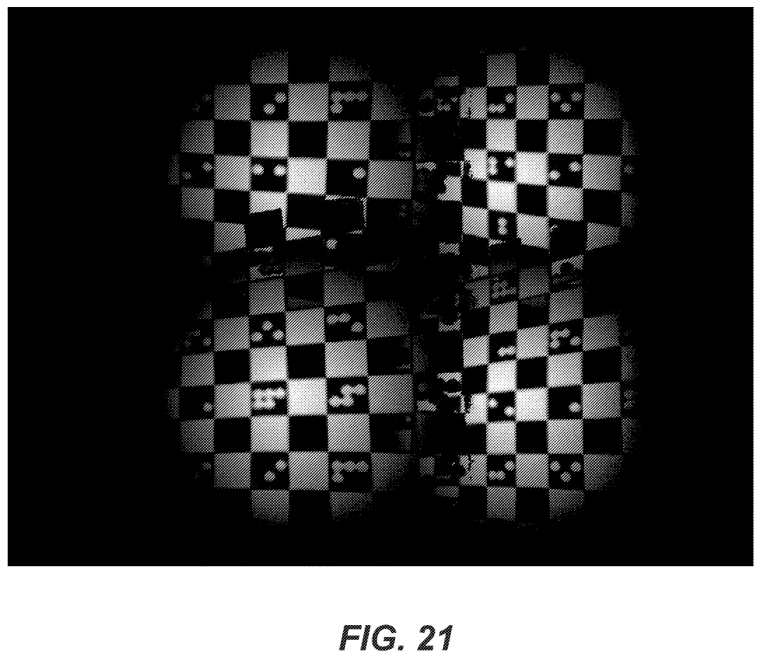

FIG. 21 is a simulated view of the image plane showing rotated and shifted views of the test pattern (using a different 4×4 lenslet array than is shown in FIG. 18) to achieve 1× magnification.

Methods and apparatus described herein can be particularly useful when used with light energy that is within a given range, such as for thermal or IR imaging, particularly in the mid-wave IR (MWIR) or long-wave IR (LWIR) regions.

The invention has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the invention is indicated by any appended claims, and all changes that come within the meaning and range of equivalents thereof are intended to be embraced therein.

### PARTS LIST

10, 10a, 10b. Imaging apparatus, portion
12. Split prism
14. Detector
16a, 16b. Splitting optics
20. Control logic processor
42, 44. Image
50. Aerial image
51. Splitter element
52. Sub-image
d. Distance
L1, L2, L3. Lens
L20a, L20b. Lens
L22a, L22b. Lens
P1, P2. Truncated parallel window
W1, W2. Wedge

What is claimed is:

1. An imaging apparatus comprising:
a) one or more lenses that have a common optical axis and that define an image plane; and
b) a splitting optic disposed to split the light along the optical axis to provide, at the same image plane, at least:
(i) a first copy of an image at a first magnification;
(ii) a second copy of the image at a second magnification different from the first magnification.

2. The apparatus of claim 1 further comprising a detector at the image plane and processing logic configured to compute distance information according to content of the first and second copies of the image.

3. The apparatus of claim 1 wherein the first and second copies are rotated with respect to each other.

4. The apparatus of claim 1 wherein the first and second copies partially overlap with respect to each other.

5. The apparatus of claim 1 wherein the first copy is a telephoto image and has a field of view fully enclosed by the second copy (wide angle).

6. The apparatus of claim 1 further comprising a corrective lens and a magnifying lens both corresponding to the at least first and second copies of the image.

7. The apparatus of claim 1 wherein the splitting optic comprises a wedge.

8. The apparatus of claim 1 wherein the splitting optic comprises a lenslet array.

9. The apparatus of claim 1 wherein the apparatus forms the first copy of the image onto the image plane at a first magnification and the second copy of the image onto the image plane at a second magnification.

10. The apparatus of claim 1 wherein neither the first copy nor second copy has the same aspect ratio as the detector array.

11. The apparatus of claim 1 wherein one or multiple baffles is introduced in image space between the image splitting components and the shared image plane, generally parallel to the original optical axis, and acting as a Field-Stop to prevent unwanted portions of individual sub-Fields-of-View from being imaged by adjacent areas on the detector.

12. A method for imaging comprising:
a) forming a first image having a first field of view of an object field onto a portion of a detector that defines an image plane; and
b) forming a second image onto the detector wherein the second image is shifted from the first image along the image plane,
and wherein the second image of the object field is at a different magnification from the first image.

13. The method of claim 12 wherein forming the first image further comprises disposing an optical wedge in the path of light to the image plane.

14. The method of claim 12 wherein forming the first image further comprises disposing an array of lenslets in the path of light to the image plane.

15. An imaging apparatus comprising:
a) one or more lenses that have a common optical axis and that define an image plane; and
b) a splitting optic disposed to split the light along the optical axis to provide, at the same image plane, at least:
(i) a first field of view;
(ii) a second field of view that includes and exceeds the first field of view.
